(19) United States
(12) Patent Application Publication
(10) Pub. No.: US 2004/0077777 A1
(43) Pub. Date: Apr. 22, 2004

(54) Aqueous polyurethane dispersion

(76) Inventors: Ulrike Licht, Mannheim (DE); Markus Antonietti, Bergholz-Rehbrucke (DE); Kathrina Landfester, Berlin (DE); Franca Tiarks, Ludwigshafen (DE)

Correspondence Address: Oblon Spivak McClellan Maier & Neustadt, Fourth Floor, 1755 Jefferson Davis Highway, Arlington, VA, 22202, US

(21) Appl. No.: 10/468,107

(22) PCT Filed: Feb. 1, 2002
(86) PCT No.: PCT/EP02/01029

(30) Foreign Application Priority Data
Feb. 15, 2001 (DE) 10107494.8

(51) Int. Cl. C08K 3/00

(52) U.S. Cl. 524/589

(57) ABSTRACT

The invention relates to aqueous primary dispersions which contain a hydrophobic polyurethane which is produced in a mini-emulsion by reacting with (a) polyisocyanate and (b) compounds containing isocyanate reactive groups. The invention also relates to a method for producing said dispersion and the use thereof for producing coatings and adhesives.

The present invention relates to aqueous primary dispersions comprising polyurethane. The present invention also relates to a process for preparing these primary dispersions and to their use.

From the prior art it is known to carry out conversions to polymers in mini emulsions. Mini emulsions are dispersions of water, an oil phase, and one or more surfactants which have a droplet size of from 5 to 50 nm (micro emulsion) or from 50 to 500 nm. The mini emulsions are considered metastable (cf. Emulsion Polymerization and Emulsion Polymers, Editors P. A. Lovell and Mohamed S. El-Aasser, John Wiley and Sons, Chichester, New York, Weinheim, 1997, pages 700 et seq.; Mohamed S. El-Aasser, Advances in Emulsion Polymerization and Latex Technology, 30^{th} Annual Short Course, Volume 3, Jun. 7-11, 1999, Emulsion Polymers Institute, Lehigh University, Bethlehem, Pa., USA). Both kinds of dispersions find broad application in the art, in cleaning products, cosmetics or body care products, for example. They can alternatively be used instead of the customary macroemulsions, whose droplet sizes are >1000 nm, for polymerization reactions.

The preparation of aqueous primary dispersions by means of the free-radical mini emulsion polymerization of olefinically unsaturated monomers is known for example from International Patent Application WO 98/02466 or from German Patents DE-A-196 28 143 and DE-A-196 28 142. In the case of these known processes the monomers can be copolymerized in the presence of different low molecular mass, oligomeric or polymeric hydrophobic substances. Furthermore, hydrophobic organic auxiliaries of low solubility in water, such as plasticizers, auxiliaries which improve the tack of the resultant film, film-forming auxiliaries or other, unspecified organic additives, can be incorporated into the monomer droplets of the mini emulsion. The polyaddition of polyisocyanates with polyols to give polyurethane in a mini emulsion is not described.

Aqueous coating materials based on aqueous primary dispersions which comprise solid core-shell particles and have been prepared by miniemulsion polymerization of olefinically unsaturated monomers in the presence of hydrophobic polymers are known from Patents EP-A-0 401 565, WO 97/49739 or EP-A-0 755 946. The polyadditions of polyisocyanates with polyols to give polyurethanes in the miniemulsion is not described.

German patent application DE 199 24 674.2 likewise describes aqueous primary dispersions and coating materials which comprise dispersed and/or emulsified, solid and/or liquid polymer particles and/or dispersed solid core-shell particles with a diameter ≦500 nm and are preparable by free-radical microemulsion or miniemulsion polymerization of an olefinically unsaturated monomer and a diarylethylene in the presence of at least one hydrophobic crosslinking agent for the copolymer resulting from the monomers. Here as well the polyaddition in miniemulsion is not described.

From the prior art it is known that ionic polyurethane dispersions are useful as coating materials, impregnations, coatings for textile, paper, leather, and plastics. Also known are numerous aqueous polyurethane adhesives. The ionic group in these dispersions not only contributes to dispersibility in water but is also an important constituent of the formula for the purpose of generating ionic interactions which influence the mechanical properties. The preparation in this prior art takes place by the acetone process or prepolymer mixing process. A disadvantage is that such processes are complicated and expensive, especially when solvents are used. Moreover, the reagents via which the hydrophilic groups are introduced are expensive, specialty chemicals.

German laid-open specification DE 198 25 453 describes, for example, dispersions comprising polyurethanes. The polyurethanes in this case are referred to as self-dispersible, the self-dispersibility being achieved through the incorporation of ionically—or non-ionically—hydrophilic groups. The dispersions in question are used to impregnate synthetic leather.

From WO 00/29465 it is additionally known that it is possible to react isocyanate and hydroxyl compound in aqueous miniemulsions to give polyurethanes. No compositions, however, are described which would allow the preparation of aqueous coatings or adhesives.

Known further from the prior art are polyurethane coating materials without hydrophilic groups, with solvents or without solvents. However, these materials exhibit disadvantages as compared with the dispersions described. Particular account must be taken of the environmental problems involved in using solvents or free isocyanate. A further disadvantage are the molar masses, which are lower in comparison with the dispersions. A further factor is that the reaction of isocyanate in an aqueous environment is always accompanied by losses due to formation of urea, which make it impossible directly to adopt the known formula of a hydrophobic polyurethane.

It is now an object of the present invention to provide primary dispersions which comprise polyurethane but which do not have the described disadvantages of the prior art. A particular aim is to prepare polyurethanes simply and inexpensively from direct conversion of the raw materials in miniemulsions. In other words, the aim is to achieve conversion to polyurethane without the intermediate step of preparing a prepolymer. Moreover, the desired properties of the polyurethane ought at the same time to have the environmental advantage of an aqueous binder. Finally, the dispersions of the invention are intended to make it possible, in the case of the production of coatings, such as varnishes and paints, to have both elasticity and hardness as a combination of properties. In the case of coatings on flexible substrates, toughness and extensibility are to be present. The use of adhesives is to be accompanied by the assurance of high bond strengths and heat durability.

This object of the invention is achieved by means of an aqueous primary dispersion comprising at least one hydrophobic polyurethane which is prepared in mini emulsion by reacting

(a) polyisocyanate and

(b) compounds having isocyanate-reactive groups.

The presence of the hydrophobic polyurethane in the primary dispersions surprisingly achieves the object of the invention. In other words, in the context of use as coating material, an outstanding elasticity arises and at the same time an outstanding hardness. On flexible substrates toughness and extensibility are assured. It is also possible to produce materials which achieve outstanding heat durabilities. In the context of use in adhesives, the high bond strength is added. Finally, the preparation of said dispersions is simple and inexpensive, since in particular the preliminary stage of preparing a prepolymer is dispensed with. Also dispensed with are the additional measures for producing self-dispersibility through incorporation of ionically or nonionically hydrophilic groups. The direct reaction of the raw materials in miniemulsion also has the effect that the desired properties of the polyurethane are unified with the environmental advantage of an aqueous binder.

In the context of the present invention the property of being hydrophilic is understood as the constitutional property of a molecule or functional group to penetrate the aqueous phase or to remain therein. Accordingly, in the context of the present invention, the property of being hydrophobic is understood as the constitutional property of a molecule or functional group to behave exophilically with respect to water, i.e., they exhibit the tendency not to penetrate water or else to depart the aqueous phase. Refer for further details to Rompp Lexikon Lacke und Druckfarben, Georg Thieme Verlag, Stuttgart, New York, 1998, “hydrophilicity”, “hydrophobicity”, pages 294 and 295.

In one preferred embodiment of the invention the ratio of isocyanate groups (a) to isocyanate-reactive groups (b) is from 0.8:1 to 3:1, preferably from 0.9:1 to 1.5:1, more preferably 1:1.

Suitable polyisocyanates in accordance with the invention include preferably the diisocyanates commonly used in polyurethane chemistry. Particular mention may be made of diisocyanates X(NCO)₂ in which X stands for an aliphatic hydrocarbon radical having 4 to 12 carbon atoms, a cycloaliphatic or aromatic hydrocarbon radical having 6 to 15 carbon atoms or an araliphatic hydrocarbon radical having 7 to 15 carbon atoms. Examples of diisocyanates of this kind are tetramethylene diisocyanate, hexamethylene diisocyanate, dodecamethylene diisocyanate, 1,4-diisocyanataocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanato toluene, 2,6-diisocyanatotoluene, 4,4′-diisocyanatodisphenylmethane, 2,4′-diisocyanatodiphenylmethane, p-xylylene diisocyanatate, tetramethylxylylene diisocyanate (TMXDI), the isomers of bis(4-isocyanatocyclohexyl)methane (HMDI) such as the trans/trans, the cis/cis, and the cis/trans isomer, and mixtures composed of these compounds.

Particularly significant mixtures of these isocyanates are the mixtures of the respective structural isomers of diisocyanatotoluene and diisocyanatodiphenylmethane: the mixture of 80 mol % 2,4-diisocyanatotoluene and 20 mol % 2,6-diisocyanatotoluene is particularly suitable. Also of particular advantage are mixtures of aromatic isocyanates such as 2,4-diisocyanatotoluene and/or 2,6-diisocyanatotoluene with aliphatic or cycloaliphatic isocyanates such as hexamethylene diisocyanate or IPDI, the preferred mixing ratio of the aliphatic to aromatic isocyanates being from 4:1 to 1:4.

As compounds (a) it is also possible to use isocyanates which in addition to the free isocyanate groups carry further, blocked isocyanate groups, e.g., isocyanurate, biuret, urea, allophanate, uretdione or carbodiimide groups.

Suitable isocyanate reactive groups by way of example are hydroxyl, thiol, and primary and secondary amino groups. Preference is given to using hydroxyl-containing compounds or monomers (b). In addition it is also possible to use amino-containing compounds or monomers (b3) as well.

As compounds or monomers (b) it is preferred to use diols.

With a view to effective film formation and elasticity, suitable compounds (b) containing isocyanate-reactive groups are principally diols (b1) of relatively high molecular mass, which have a molecular weight of approximately 500 to 5000, preferably of approximately 1000 to 3000 g/mol.

The diols (b1) are, in particular, polyester polyols, which are known for example from Ullmanns Encyklopaedie der technischen Chemie 4th Edition, Volume 19, pp. 62-65. It is preferred to use polyester polyols which are obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids can be aliphatic, cycloaliphatic, araliphatic, aromatic or heterocyclic and can where appropriate be unsaturated and/or substituted, by halogen atoms for example. Examples thereof that may be mentioned include the following: suberic acid, azeleic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, alkenyl succinic acid, fumaric acid, dimeric fatty acids. Preferred dicarboxylic acids are of the general formula HOOC—(CH₂)₇—COOH, in which y is a number from 1 to 20, preferably an even number from 2 to 20, e.g. succinic acid, adipic acid, dodecane-dicarboxylic acid and sebacic acid.

Examples of suitable diols include ethylene glycol, propane-1,2-diol, propane-1,3-diol, butane-1,3-diol, butane-1,4-diol, butene-1,4-diol, butyne-1,4-diol, pentane-1,5-diol, neopentylglycol, bis(hydroxymethyl)cyclohexanes such as 1,4-bis(hydroxymethyl)cyclohexane, 2-methylpropane-1,3-diol, methylpentanediols, and diethylene glycol, triethylene glycol, tetraethylene glycol, polyethylene glycol, dipropylene glycol, polypropylene glycol, dibutylene glycol and polybutylene glycols. Preferred alcohols are of the general formula HO—(CH₂)ₓ—OH, in which x is a number from 1 to 20, preferably an even number from 2 to 20. Examples thereof are ethylene glycol, butane-1,4-diol, hexane-1,6-diol, octane-1,8-diol, and dodecane-1,12-diol. Also preferred are neopentyl glycol and pentane-1,5-diol. These diols can also be used as diols (b2) directly for the synthesis of the polyurethanes.

Further suitable diols include polycarbonate-diols (b1), as may be obtained, for example, by reacting phosgene with an excess of the low molecular mass alcohols cited as synthesis components for the polyester polyols.

Also suitable are lactone-based polyester diols (b1), which are homopolymers or copolymers of lactones, preferably hydroxyl-terminated adducts of lactones with suitable difunctional starter molecules. Suitable lactones are preferably those derived from compounds of the general formula HO—(CH₂)₂—COOH, in which z is a number from 1 to 20 and one H atom of a methylene unit may also have been substituted by a C₁ to C₄ alkyl radical. Examples are epsilon-caprolactone, β-propiolactone, γ-butyrolactone and/or methyl-epsilon-caprolactone, and mixtures thereof. Suitable starter components are, for example, the low molecular mass dihydric alcohols cited above as a synthesis component for the polyester polyols. The corresponding polymers of γ-caprolactone are particularly preferred. Lower polyester diols or polyether diols as well can be used as starters for preparing the lactone polymers. Instead of the polymers of lactones it is also possible to use the corresponding, chemically equivalent polycondensates of the hydroxy carboxylic acids which correspond to the lactones.

Further suitable monomers (b1) are polyether diols. They are obtainable in particular by polymerization of ethylene oxide, propylene oxide, butylene oxide, tetrahydrofuran, styrene oxide or epichlorohydrin with itself, in the presence of BF₃, for example, or by addition reaction of these compounds, where appropriate as a mixture or in succession, with starting components containing reactive hydrogen atoms, such as alcohols or amines, e.g., water, ethylene glycol, propane-1,2-diol, 1,2-bis(4-hydroxyphenyl)propane or aniline. Particular preference is given to polytetrahydrofuran with a molecular weight of from 240 to 5000, and in particular from 500 to 4500.

Likewise suitable are polyhydroxy olefins (b1), preferably those having 2 terminal hydroxyl groups, e.g., α-ω-dihydroxypolybutadiene, α-ω-dihydroxypolymethacrylic esters or α-ω-dihydroxypolyacrylic esters, as monomers (b1). Such compounds are known for example from EP-A-0 622 378. Further suitable polyols (b1) are polyacetals, polysiloxanes, and alkyd resins.

In lieu of the diols (b1) it is also possible in principle to use low molecular mass isocyanate-reactive compounds having a molecular weight of from 62 to 500, in particular from 62 to 200 g/mol. It is preferred to use low molecular mass diols (b2).

As diols (b2) use is made of short-chain alkane diols cited in particular as synthesis components for the preparation of polyester polyols, preference being given to the unbranched diols having 2 to 12 carbon atoms and an even number of carbon atoms, and also to pentane-1,5-diol. Further suitable diols (b2) include phenols or bisphenol A or F.

The hardness and the modulus of elasticity of the polyurethanes can be increased by using not only the diols (b1) but also the low molecular mass diols (b2) as diols (b).

The fraction of the diols (b1), based on the total amount of the diols (b), is preferably from 0 to 100, in particular from 10 to 100, with particular preference from 20 to 100 mol %, and the fraction of the monomers (b2), based on the total amount of the diols (b), is preferably from 0 to 100, in particular from 0 to 90, with particular preference from 0 to 80 mol %. With especial preference the molar ratio of diols (b1) to the monomers (b2) is from 1:0 to 0:1, preferably from 1:0 to 1:10, more preferably from 1:0 to 1:5.

For component (a) and (b) it is also possible to use functionalities>2.

Examples of suitable monomers (b3) are hydrazine, hydrazine hydrate, ethylenediamine, propylenediamine, diethylenetriamine, dipropylenetriamine, isophoronediamine, 1,4-cyclohexyldiamine or piperazine.

In a minor amount it is also possible to use monofunctional hydroxyl-containing and/or amino-containing monomers. Their fraction should not exceed 10 mol % of components (a) and (b).

The preparation of the dispersion of the invention is carried out by means of miniemulsion polymerization.

These processes generally entail a first step of preparing a mixture from the monomers (a) and (b), the required amount of emulsifiers and/or protective colloid, optionally hydrophobic additive, and water and generating from said mixture an emulsion.

In accordance with the invention the diameters of the monomer droplets in the emulsion thus prepared are normally <1000 nm, frequently <500 nm. In the normal case the diameter is >40 nm. Preference is given accordingly to values between 40 and 1000 nm. Particularly preferred are 50-500 nm. A very particularly preferred range is that from 100 nm to 300 nm and an especially preferred range is that from 200 to 300 nm.

The emulsion prepared in the manner described is heated with further stirring until the theoretical conversion has been reached. The average size of the droplets of the dispersed phase of the aqueous emulsion can be determined in accordance with the principle of quasi elastic light direction (the so-called z-average droplet diameter dz of the unimodal analysis of the autocorrelation function). This can be done using for example a Coulter N3 Plus Particle Analyser from Coulter Scientific Instruments.

The emulsion may be prepared employing, for example, high-pressure homogenizers. In these machines the fine distribution of the components is obtained by means of a high local energy input. Two variants have proven particularly appropriate in this respect:

In the first variant the aqueous macroemulsion is compressed to more than 1000 bar by means of a piston pump and is then released through a narrow gap. The action here is based on an interplay of high shear gradients and pressure gradients and cavitation in the gap. One example of the high-pressure homogenizer which operates in accordance with this principle is the Niro-Soavi high-pressure homogenizer model NS1001L Panda.

In the second variant, the compressed aqueous macroemulsion is released into a mixing chamber by way of two mutually opposed nozzles. In this case the action of fine distribution depends above all on the hydrodynamic conditions within the mixing chamber. One example of this type of homogenizer is the model M 120 E microfluidizer from Microfluidics Corp. In this high-pressure homogenizer the aqueous macroemulsion is compressed by means of a pneumatic piston pump to pressures of up to 1200 atm and is released through an “interaction chamber”. Within the interaction chamber the emulsion jet is divided in a microchannel system into two jets which are caused to collide at an angle of 180°. Another example of a homgenizer operating in accordance with this mode of homogenization is the nanojet model Expo from Nanojet Engineering GmbH. With the nanojet, however, instead of a fixed channel system, two homogenizing valves are installed which can be adjusted mechanically.

In addition to the principles illustrated above, however, homogenization may also be brought about, for example, by the use of ultrasound (e.g. Branson Sonifier II 450). In this case the fine distribution is the result of cavitation mechanisms. For ultrasonic homogenization the devices that are described in GB 22 50 930 A and in U.S. Pat. No. 5,108,654 are also suitable in principle. The quality of the aqueous emulsion E1 produced in the sonic field depends not only on the sonic power input but also on other factors, such as the intensity distribution of the ultrasound in the mixing chamber, the residence time, the temperature, and the physical properties of the substances to be emulsified—for example, on the viscosity, surface tension, and vapor pressure. The resultant droplet size depends in this case, among other factors, on the concentration of the emulsifier and also on the energy input for homogenization, and may therefore be adjusted specifically by making corresponding changes to the homogenizing pressure and/or to the corresponding ultrasound energy.

For preparing the emulsion of the invention from conventional emulsions by means of ultrasound, the device described in German patent application DE 197 56 874.2 has proven particularly appropriate. This is a device having a reaction chamber or a through-flow reaction channel and having at least one means of transmitting ultrasonic waves to the reaction chamber or through-flow reaction channel, the means of transmitting ultrasonic waves being configured so that the entire reaction chamber or the through-flow reaction channel in a subsection may be sonicated uniformly with ultrasonic waves. For this purpose the emitting surface of the means of transmitting ultrasonic waves is designed in such a way that it corresponds essentially to the surface of the reaction chamber and, if the reaction chamber is a subsection of a through-flow reaction channel, extends essentially over the entire width of the channel, and in such a way that the reaction chamber depth which is essentially vertical with respect to the emitting surface is smaller than the maximum effective depth of the ultrasound transition means.

The term “reaction chamber depth” refers here essentially to the distance between the emitting surface of the ultrasound transmission means and the floor of the reaction chamber.

Reaction chamber depths of up to 100 mm are preferred. With advantage the depth of the reaction chamber should not be more than 70 mm, and with particular advantage not more than 50 mm. The reaction chambers may in principle also have a very small depth, although in view of minimizing the risk of clogging, maximum ease of cleaning, and high product throughput, preference is given to reaction chamber depths which are substantially greater than, for instance, the usual gap height in the case of high-pressure homogenizers, and usually more than 10 mm. The reaction chamber depth is advantageously alterable, as a result, for example, of ultrasound transmission means which protrude into the housing to different extents.

In accordance with the first embodiment of this device the emitting surface of the means of transmitting ultrasound corresponds essentially to the surface of the reaction chamber. This embodiment is used for the batchwise production of emulsions. With the device of the invention it is possible for ultrasound to act on the entire reaction chamber. Within the reaction chamber the axial pressure of sonic irradiation generates a turbulent flow which brings about intensive cross-mixing.

In accordance with a second embodiment a device of this kind has a through-flow cell. In this case the housing is designed as a through-flow reaction channel, with an inlet and an outlet, the reaction chamber being a subsection of the through-flow reaction channel. The width of the channel is that extent of the channel which runs essentially perpenducular to the flow direction. In this arrangement the emitting surface covers the entire width of the flow channel transversely to the flow direction. That length of the emitting surface which is perpendicular to the this width, in other words the length of the emitting surface in the flow direction, defines the effective range of the ultrasound. In accordance with one advantageous variant of this first embodiment the through-flow reaction channel has an essentially rectangular cross section. If a likewise rectangular ultrasound transmission means of appropriate dimensions is installed in one side of the rectangle, particularly effective and uniform sonication is ensured. Owing to the turbulent flow conditions which prevail in the ultrasonic field, however, it is also possible, for example, to use a circular transmission means without close parts. Furthermore, it is possible in lieu of a single ultrasound transmission means to arrange two or more separate transmission means which are connected in series as viewed in the flow direction. In such an arrangement it is possible for not only the emitting surfaces but also the depth of the reaction chamber, in other words the distance between the emitting surface and the floor of the through-flow channel, to vary.

With particular advantage the means of transmitting ultrasonic waves is designed as a sonotrode whose end remote from the free emitting surface is coupled to an ultrasound transducer. The ultrasonic waves may be generated, for example, by exploiting the inverse piezoelectric effect. In this case, generators are used to generate high-frequency electrical oscillations (usually in the range from 10 to 100 kHz, preferably between 20 and 40 kHz), and these are converted by a piezoelectric transducer into mechanical vibrations of the same frequency and, with the sonotrode as transmission element, are coupled into the medium that is to be sonicated.

With particular preference the sonotrode is designed as a rod-shaped, axially emitting ½ (or multiples of ½) longitudinal oscillator. A sonotrode of this kind may be given a pressure tight design by means, for example, of a flange provided on one of its nodes of oscillation in an aperture of the housing, so that the reaction chamber can be sonicated even under superatmospheric pressure. Preferably, the amplitude of oscillation of the sonotrode can be regulated, i.e., the particular oscillation amplitude set is monitored online and, if necessary, is corrected automatically. The current oscillator amplitude can be monitored, for example, by means of a piezoelectric transducer mounted on the sonotrode or by means of a strain gauge with downstream evaluation electronics.

In accordance with a further advantageous design of such devices the reaction chamber contains internals for improving the flow behavior and mixing behavior. These internals may comprise, for example, simple deflector plates or any of a wide variety of porous structures. If required, mixing may be made more intensive by means of an additional stirrer mechanism. The temperature of the reaction chamber is advantageously controllable.

It is advantageous to carry out the preparation of the emulsion with a rapidity such that the emulsifying time is small in comparison to the reaction time of the monomers with one another and with water.

One preferred embodiment of the process of the invention comprises preparing the entirety of the emulsion with cooling to temperatures <RT. The emulsion preparation is preferably accomplished in less than 10 min. By raising the temperature of the emulsion with stirring the conversion is completed. The reaction temperatures are between RT and 120° C., preferably between 60° and 100° C.

In another embodiment of the process of the invention the emulsion is first prepared from the monomers (a) and (b1) and/or (b2), emulsifiers and protective colloids, optionally hydrophobe and water and, after the theoretical NCO content has been reached, the monomers (b3) are added dropwise.

In the production of miniemulsions is generally the case that ionic and/or nonionic emulsifiers and/or protective colloids or stabilizers are used as surface-active compounds.

A detailed description of suitable protective colloids is given in Houben-Weyl, Methoden der organischen Chemie, Volume XIV/1, Makromolekulare Stoffe, [Macromolecular Compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are normally below 2000 g/mol. Where mixtures of surface-active substances are used it will be appreciated that the individual components must be compatible with one another, something which in the case of doubt can be checked by means of a few preliminary tests. Preferably, anionic and nonionic emulsifiers are the surface-active substances used. Customary accompanying emulsifiers are, for example, ethoxylated fatty alcohols (EO units: 3 to 50, alkyl: C₈ to C₃₆), ethoxylated mono-, di- and tri-alkyl phenols (EO units: 3 to 50, alkyl: C₄ to C₉), alkali metal salts of dialkyl esters of sulfo succinic acid and also alkali metal salts and/or ammonium salts of alkyl sulfates (alkyl: C₈ to C₁₂), of ethoxylated alkanols (EO units: 4 to 30, C₉), of alkyl sulfonic acids (alkyl: C₁₂ to C₁₈) and of alkylarsulfonic acids (alkyl: C₉ to C₁₈).

Suitable emulsifiers are also found in Houben-Weyl, Methoden der organischen Chemie Volume 14/1, Makromolekulare Stoffe [Macromolecular Compounds], Georg Thieme Verlag, Stuttgart, 1961, pages 192 to 208. Examples of emulsifier trade names are Dowfax® 2 A1, Emulan® NP 50, Dextrol® OC 50, Emulgator 825, Emulgator 825 S, Emulan® OG, Texapon® NSO, Nekanil® 904 S, Lumiten® 1-RA, Lumiten E 3065, Steinapol NLS etc.

The amount of emulsifier for preparing the aqueous emulsion is appropriately chosen in accordance with the invention such that in the aqueous emulsion which ultimately results the critical micelle concentration of the emulsifiers used is essentially not exceeded within the aqueous phase. Based on the amount of monomers present in the aqueous emulsion this emulsifier amount is generally in the range from 0.1 to 5% by weight. As already mentioned, the emulsifiers can be admixed on the side with protective colloids which are able to stabilize the disperse distribution of the aqueous polymer dispersions which ultimately results. Irrespective of the amount of emulsifier employed, the protective colloids can be used in amounts of up to 50% by weight: for example, in amounts of from 1 to 30% by weight based on the monomers.

Compounds which can be added as costabilizers to the monomers, in amounts of from 0.01% by weight to 10% by weight (0.1-1%), are compounds which have a solubility in water of <5×10⁻⁵, preferably 5×10⁻⁷ g/l. Examples are hydrocarbons such as hexadecane, halogenated HCs, silanes, siloxanes, hydrophobic oils (olive oil), dyes, etc. In their stead it is also possible for blocked polyisocyanates to take on the function of the hydrophobe.

The dispersion of the invention is used to prepare aqueous coating materials, adhesives, and sealants. It can also be used to produce films or sheets and also to impregnate textiles, for example.

In the text below the invention is described in more detail with reference to examples.

### EXAMPLES

### Preparation of an Inventive Dispersion

For examples 1 to 11 mixtures were prepared from the monomers (a) and (b), emulsifiers, hydrophobic additive (costabilizer), and water. The quantitative composition of the mixtures of the invention is given in Table 1.

The mixture thus prepared was stirred at 0° C. for approximately 1 hour. The inventive emulsion was prepared at room temperature by means of ultrasound (Branson sonifier W450 Digital) for 120 seconds at an amplitude of 90%. For the polymerization the temperature was raised to 68° C. Following complete conversion (checking of the isocyanate content and polyurethane content by means of IR spectroscopy), the droplet size of the dispersed phase was determined with the aid of light scattering (Nicomp particle sizer, model 370). In addition, measurements were made of the dispersion's glass transition temperature by means of calorimetry (Netzsch DSC200) and of its surface tension by the DuNouy ring method. Additionally, the amount of coagulum in the emulsion was measured. The results are summarized in Table 2.

The inventive dispersions were outstandingly suitable for preparing coating materials, adhesives, and sealants. The inventive coating materials, adhesives, and sealants gave coatings, adhesive layers, and seals having very good performance properties.

TABLE 1
Physical composition of the mini emulsions of Examples 1 to 11

| [g] | 1 | 2 | 3 | 4 | 5 | 6 | 7 | 8 | 9 | 10 | 11 |
|---|---|---|---|---|---|---|---|---|---|---|---|
| Isophorone | 3.5 | 3.4 | 3.4 | 3.4 | 3.3 | 3.4 | 3.3 | | | | |
| diisocyanate | | | | | | | | | | | |
| Lupranat T 80¹⁾ | | | | | | | | 0.26 | 0.55 | 0.79 | 0.26 |
| 1,12-dodecanediol | 3.0 | 3.0 | 3.0 | 3.0 | | 2.0 | | | | | |
| Bisphenol A | | | | | 3.4 | | 2.3 | | | | |
| Neopentyl glycol | | | | | | 0.5 | 0.5 | | | | 0.05 |
| Lupranol 1000²⁾ | | | | | | | | 3.0 | 3.0 | 3.0 | 1.0 |
| SDS³⁾ | 0.25 | 0.1 | 0.05 | 0.025 | 0.1 | 0.25 | 0.25 | 0.3 | 0.3 | 0.3 | 0.25 |
| Hexadecane | 0.15 | 0.15 | 0.15 | 0.15 | 0.25 | 0.25 | 0.25 | 0.13 | 0.12 | 0.12 | 0.15 |
| Water | 30.1 | 30.2 | 30.6 | 30.6 | 20.2 | 20.2 | 20.2 | 20.3 | 20.7 | 20.3 | 20.1 |

¹⁾80% toluene 2,4-diisocyanate and 20% toluene 2,4-diisocyanate
²⁾Linear polyether polyol with molecular weight H_{V} 2000
³⁾Sodium dodecyl sulfate

TABLE 2
Characteristics of the dispersions of Examples 1 to 11

| | 1 | 2 | 3 | 4 | 5 | 6 | 7 | 8 | 9 | 10 | 11 |
|---|---|---|---|---|---|---|---|---|---|---|---|
| Droplet size [nm] | 202 | 208 | 232 | 229 | 228 | 167 | 232 | 163 | 116 | 107 | 163 |
| Glass transition | about | about | about | about | 98 | | | −62 | −62 | −62 | −62 |
| temperature [° C.] | 50 | 50 | 50 | 50 | | | | | | | |
| Surface tension [mN/m] | 41.8 | 50.9 | 55.4 | 57.6 | 46.1 | 35.6 | 36.6 | 32.2 | 33.7 | 34.0 | 35.6 |
| Coagulum [%] | <5 | <5 | 15 | 43 | <5 | — | — | — | 33 | 57 | — |

1. An aqueous primary dispersion comprising at least one hydrophobic polyurethane which is prepared in mini emulsion by reacting
(a) at least one polyisocyanate and
(b) at least one compound having isocyanate-reactive groups.

2. Dispersions as claimed in claim 1, characterized in that the ratio of the component (a) to component (b) is from 0.8:1 to 3:1.

3. Dispersion as claimed in one of claims 1 or 2, characterized in that the ratio of component (a) to component (b) is from 1.5:1 to 0.9:1.

4. Dispersion as claimed in one of the claims up to 3, characterized in that the ratio of component (a) to component (b) is 1:1.

5. Dispersion as claimed in one of claims 1 to 4, characterized in that isocyanate-reactive compounds having a molar weight of <500 g/mol and/or isocyanate-reactive compounds having a molar weight of >500 g/mol are used.

6. Dispersion as claimed in one of claims 1 to 5, characterized in that it comprises further, monofunctional monomers with a fraction of <10 mol % based on components (a) and (b).

7. Dispersion as claimed in one of claims 1 to 6, characterized in that component (a) comprises diisocyanates.

8. Dispersion as claimed in one of claims 1 to 7, characterized in that component (b) comprises diols.

9. Dispersions as claimed in claim 8, characterized in that based on the total amount of the diols (b) from 0 to 100 mol % of the diols (b1) with a molecular weight >500 g/mol and from 100 to 0 mol % of the diols (b2) with a molecular weight <500 g/mol are used.

10. Dispersions as claimed in claim 9, characterized in that based on the total amount of the diols (b) from 10 to 100 mol % of the diols (b1) with a molecular weight >500 g/mol and from 90 to 0 mol % of the diols (b2) with a molecular weight <500 g/mol are used.

11. Dispersions as claimed in claim 10, characterized in that based on the total amount of the diols (b) from 20 to 100 mol % of the diols (b1) with a molecular weight >500 g/mol and from 80 to 0 mol % of the diols (b2) with a molecular weight <500 g/mol are used.

12. Dispersions as claimed in one of claims 1 to 11, characterized in that component (b) comprises amino-containing compounds (b3).

13. A process for preparing a dispersion as claimed in one of claims 1 to 12 characterized in that
1) a mixture of the monomers (a) and (b), emulsifiers and/or protective colloids in water is prepared,
2) an emulsion is produced, and
3) the emulsion is heated with further stirring until components (a) and (b) have undergone conversion to polyurethane.

14. The process as claimed in claim 13, characterized in that in step 1 a monomer mixture of isocyanates (a) and also isocyanate-reactive compounds (b1), (b2), and (b3) is used.

15. The process as claimed in one of claims 13 or 14, characterized in that the emulsion is prepared in high-pressure homogenizers.

16. The process as claimed in one of claims 13 to 15, characterized in that emulsions having monomer droplet sizes of 40 -1000 nm are prepared.

17. The process as claimed in one of claims 13 to 16, characterized in that emulsions having monomer droplet sizes of 50-500 nm are prepared.

18. The process as claimed in one of claims 13 to 17, characterized in that emulsions having monomer droplet diameters of 100-300 nm are prepared.

19. The process as claimed in one of claims 13 to 18, characterized in that emulsions having monomer droplets of 200-300 nm are prepared.

20. The use of the dispersion as claimed in one of claims 1 to 12 to prepare aqueous coating materials, adhesives, impregnations, and sealants.
